(19) United States
(12) Patent Application Publication
(10) Pub. No.: US 2004/0200623 A1
(43) Pub. Date: Oct. 14, 2004

(54) Attenuating horseshoe

(76) Inventor: Matt Kriesel, Melrose, WI (US)

Correspondence Address: Womble Carlyle Sandridge & Rice, PLLC, P.O. Box 7037, Atlanta, GA, 30357-0037, US

(21) Appl. No.: 10/401,127

(22) Filed: Mar. 27, 2003

(51) Int. Cl. A01L 1/00

(52) U.S. Cl. 168/4

(57) ABSTRACT

Disclosed is an attenuating horseshoe for reducing the vibrational energy transferred from the shoes of the horse to the leg of the animal. The attenuating horseshoe includes a substantially rigid shoe with a central toe having branches extending from each end of the central toe. A channel is formed within each of the branches and an attenuating material substantially fills each of the channels. The attenuating material may comprise a resilient material.

### FIELD OF THE INVENTION

The present invention generally relates to horseshoes and in particular it relates to horseshoes which attenuate vibrational energy transferred to the leg of the animal.

### BACKGROUND OF THE INVENTION

The major purpose of a horseshoe is to protect the horse's hooves against injury and to add traction. In a race horse, a properly designed horseshoe is an important piece of equipment which can enhance the horse's racing performance and can add years to the length of the horse's racing career. When a horse is running, its hooves hit the ground with a great deal of impact. Under certain running conditions, a horse's stride can cause all of its weight to land on one hoof. This impact is transmitted through the hoof and up through the horse's legs. Unless great care is taken to protect the horse's legs and hooves against impact and vibrational damage, the horse can develop sore feet and lame legs due to corns, cracks and other damage.

A 1500 pound race horse running at about 30 miles per hour places a heavy impact load on its feet especially when there is a peak shock load at the moment of impact. A metal horseshoe is shaped as a “U”, and when the horseshoe is struck at the moment of impact the shoe will vibrate causing it to “ring” and transmit damaging vibrational energy up the horse's leg. Furthermore, the shoe is tightly attached to the hoof by nails so the ringing vibration is readily transmitted to the animal's leg.

Additionally, this vibrational energy works on the nails, adding to the tendency of the nails to loosen as the result of flexure of the hoof itself. This loosening of the shoes due to such vibrational energy can result in the shoes being thrown during vigorous exercise and racing. Expensive race horses may need to be re-shod as frequently as every four to five weeks. It is an economic advantage to lengthen this period, especially for less valuable horses whose earnings cannot support optimum care.

One method for dampening such vibrational energies includes the use of a metal shoe with a layer of shock-absorbing solid organic plastic material cemented to the upper surface of the metal shoe. When the animal is shod, nails are pounded into the hoof through the shoe with the pad bearing against the hoof. The pad is disposed between the metal shoe and the hoof itself.

Unfortunately, such a pad and shoe combination does not hold up to the additional component of motion on the hoof. Reduction of vibration is thought to rely heavily on a tight intimate joinder of the pad and the shoe, as well as of the pad and the hoof. Upon impact, the hoof begins a twisting motion around the hoof axis which imparts an additional shear force on the cement layer which holds the pad to the metal shoe. The pad often separates under strain, especially at the end portions of each arm where there is insufficient hoof material to receive a nail. Furthermore, since the two ends of the shoe do not strike the ground first, there is a strong force tending to peel the pad from the metal shoe.

One solution to counter such separation of pad and shoe has been to rivet the pad to the metal shoe with a countersunk rivet whose head is sunk in the pad. Unfortunately, when the pad wears, the rivet head becomes exposed and contacts the hoof. This can cause a corn on the hoof, which is intolerable for a race horse. Also, the active rubbing together of the rivet shank and rivet head on the pad can cause undesirable wear on the pad and lead to premature separation.

Thus, what is needed is a horseshoe system that does not rely on a pad or other vibrational absorption device susceptible to movement and displacement while the animal is in motion to prevent damaging vibrational energy from being transferred to the leg of the animal.

### SUMMARY

The present invention comprises an attenuating horseshoe for reducing the vibrational energy transferred from the shoes of the horse to the leg of the animal. The horseshoe includes an attenuating material that dampens the vibrational energy as it enters the shoe as the horse races.

In greater detail, the attenuating horseshoe comprises a shoe with a central toe having a first and second branch extending from the central toe of the shoe. A channel is formed within the shoe. Typically, the channel is formed within each of the branches and may further run through the central toe. An attenuating material is disposed within the channel for reducing the vibrational energy transmitted through the shoe. The attenuating material may comprise a resilient material. A coating may be applied such that it covers the channel.

Additionally, the resilient material may be selected from the group consisting of thermoplastic elastomers, crosslinked elastomers, noncrosslinked rubbery materials and combinations thereof. The elastomeric material may include a polymeric gel having a crosslinked elastomeric polymer. Furthermore, the attenuating material is substantially flush and contained within the walls forming the channel.

In a further embodiment, the attenuating horseshoe includes a substantially rigid shoe having a recess formed in the shoe. Furthermore, the shoe may have a plurality of recesses. An attenuating material is then disposed within the recess. The attenuating material may comprise either a liquid or resilient material and a covering sealing the attenuating material in the channel.

### DRAWINGS

In the Drawings:

FIG. 1 illustrates the attenuating horseshoe having a continuous channel running through the shoe and filled with the attenuating material;

FIG. 2 depicts the attenuating horseshoe having a channel filled with the attenuating material running through each of the branches of the shoe;

FIG. 3 illustrates the attenuating horseshoe having discontinuous channels or recesses running through the shoe and filled with the attenuating material;

FIG. 4 illustrates the attenuating horseshoe having a coating covering the channels filled with the attenuating material; and

FIG. 5 depicts the side view of the attenuating horseshoe showing the hoof side and turf side of the shoe.

### DETAILED DESCRIPTION

The present invention comprises an attenuating horseshoe for reducing vibrational energy transferred from the shoes of a horse to the leg of the animal. The vibrational energy, which can be damaging to the animal's leg, is dampened by the inclusion of an attenuating material added to the shoe. Typically, this attenuating material forms an integral part of the shoe by filling a channel formed within the horseshoe. The attenuating material may be comprised of a polymeric gel fitted within the channel or recess. Furthermore, the shoe may include a coating covering the channel containing the attenuating material.

In greater detail, the attenuating horseshoe comprises a horseshoe. The shoe may be formed from most any material typically used in the art of making a horseshoe. For example, the horseshoe may be formed from a metal or hardened resilient material. The horseshoe may be applied to the hoof of the animal using mechanical fastening devices, such as nails, or an adhesive may be used to attach the shoe to the horse. The shoe has a side which contacts the hoof and a side that contacts the ground when in use.

The channel formed within the horseshoe may have varying dimensions. For example, the channel may be dimensioned depending upon the amount of attenuating material desired to be added to the horseshoe. The quantity of attenuating material may be regulated by the volume of the channel. Greater quantities of attenuating material typically result in reduced vibrational energy transferred to the horse's leg.

The channel may run the entire length of the shoe. Additionally, the channel or recess may run intermittently throughout the horseshoe. For example, each branch of the shoe may have an individual, disconnected, channel formed within. Furthermore, the intermittent recesses may consist of individual cells formed within the shoe. The recesses or channels may extend through the entire shoe or the recesses may extend into the shoe such that the channels have a floor and sidewalls. The channel can be formed within the shoe in the hoof portion or the portion contacting the ground. The channel or recess may be formed by either removing material from the shoe or by forging or stamping the channel into the shoe.

The attenuating material may be comprised of any material capable of dampening or attenuating the vibrational energy transferred through the horseshoe. For example, the attenuating material may comprise a material formed from a resilient material such as rubber, plastic or gel. Additionally, the resilient material may be selected from the group consisting of thermoplastic elastomers, crosslinked elastomers, noncrosslinked rubbery materials and combinations thereof. The elastomeric material may include a polymeric gel having a crosslinked elastomeric polymer.

The attenuating material may fill all or part of the channel or recess formed within the shoe. The recess receives the attenuating material either in a liquid or solid form. Furthermore, in an embodiment, the attenuating material is substantially flush and contained within the walls forming the channel. Substantially flush is defined in an embodiment to include an inconsequential over or under filling of the channel. In a further embodiment, the channel is filled with the attenuating material at a level such that the attenuating material does not provide a shock absorbing surface but only a vibrational dampening force.

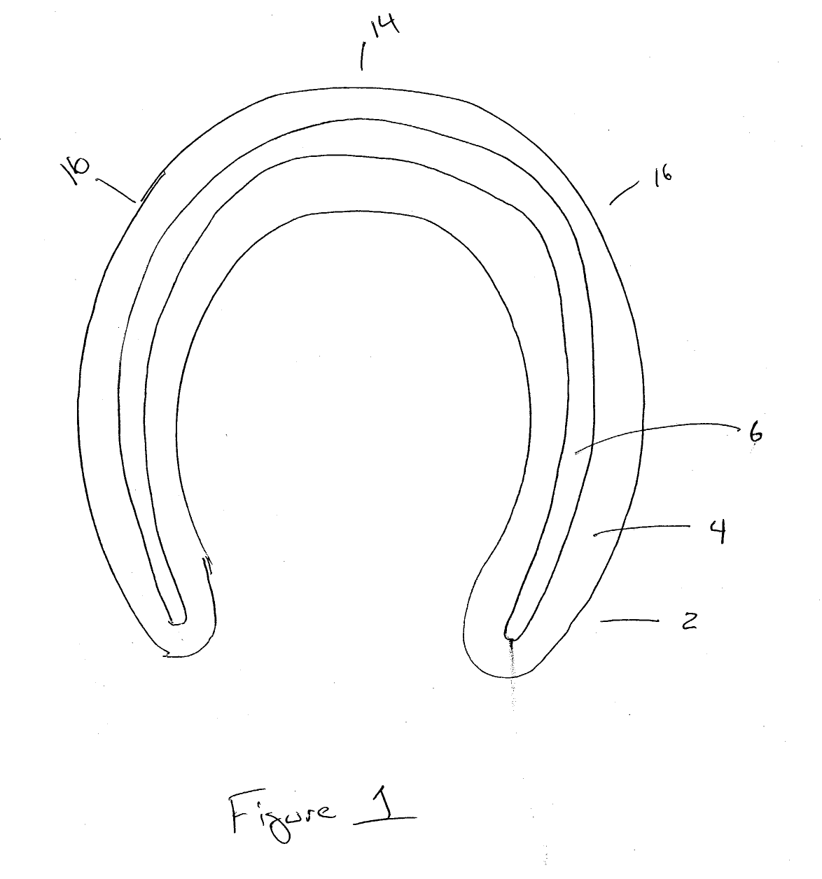

Referring now to the drawings wherein like numerals of reference refer to like elements throughout. In FIG. 1, the attenuating horseshoe is depicted including the horseshoe 2 having a central toe portion 14 and branches 16 extending therefrom. The horseshoe 2 includes a channel or recess 4 having an attenuating material 6 confined therein. The channel 4 is depicted as being continuous throughout the horseshoe 2 such that it extends substantially the toe portion 14 and the respective branches 16.

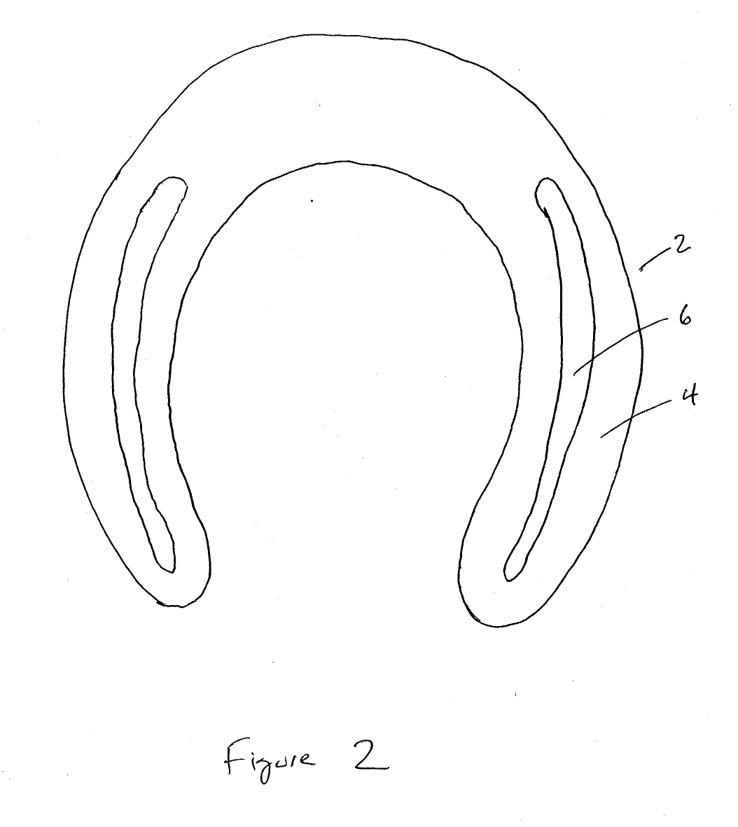

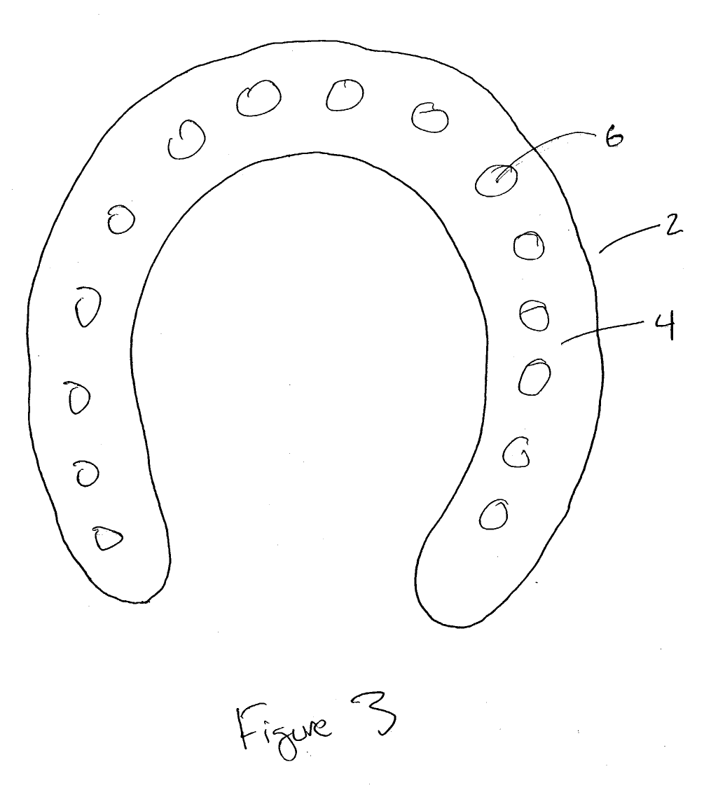

FIG. 2 depicts the horseshoe 2 having channels 4 residing within the branches 16 of the horseshoe 2. In a further embodiment not depicted, the channel 4 may also run through the toe 14 and excluding the branches 16. The channels 4 have the attenuating material 6 disposed within. FIG. 3 further depicts the horseshoe 2 having intermittent recesses 4 dispersed throughout the horseshoe 2. The pattern and number of the intermittent recesses 4 is not critical, and additional patterns are contemplated. The attenuating material 6 is disposed within the intermittent recesses 4. The attenuating material 6 need not be disposed within each and every of the depicted intermittent recesses 4.

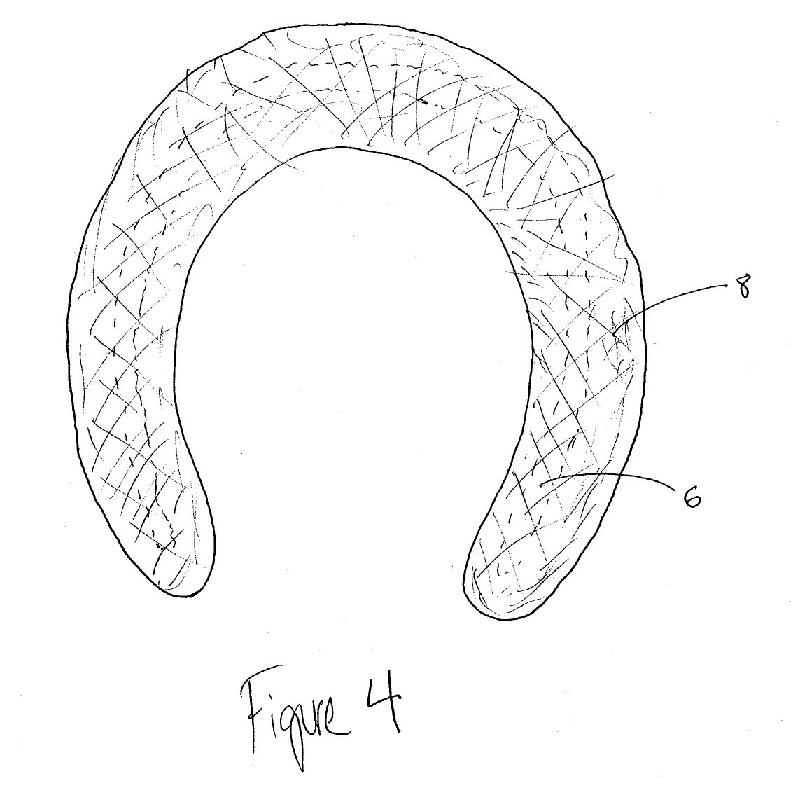

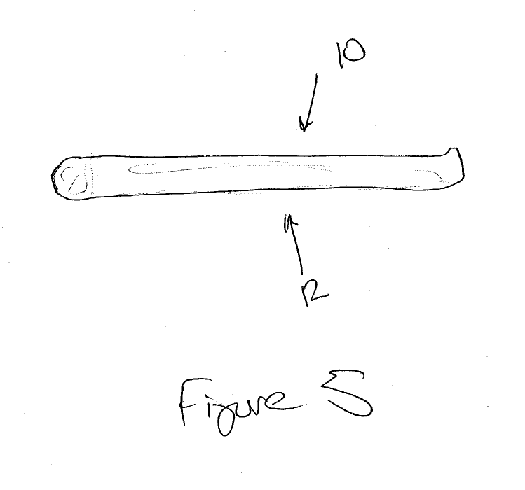

FIG. 4 illustrates the horseshoe 2 having a coating 8. The coating may be applied only to the recess 4 areas having the attenuating material 6 therein, or the coating may be applied to the entire horseshoe 2. In a further embodiment, the coating may be applied only to one side of the horseshoe 2. The coating 8 may be comprised of any durable material such as a polyurethane. FIG. 5 is a side view of the horseshoe depicting hoof side 12 of the horseshoe 2 and the turf side 10 of the horseshoe 2.

While Applicant has set forth an embodiment as illustrated and described above, it is recognized that variations may be made with respect to the disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

1. An attenuating horseshoe comprising:
a shoe with a toe having a first and second branch extending therefrom;
a channel formed in the shoe;
a polymeric gel disposed in the channel such that the polymeric gel filling the channel substantially flush with the surface of the shoe; and
a coating covering the gel filled channel.

2. (Canceled).

3. The horseshoe of claim 1, wherein the coating comprises a polyurethane.

4. (Canceled).

5. (Canceled).

6. (Canceled).

7. The horseshoe of claim 1, wherein the polymeric gel comprises polybutadiene, a plasticizer, a prepolymer and a stabilizer.

8. The horseshoe of claim 7, wherein the prepolymer comprises an isocyanate.

9. The horseshoe of claim 7, wherein the stabilizer comprises an alkyl tin compound.

10. The horseshoe of claim 1, wherein the attenuating material is substantially flush with an edge of the channel.

11. the horseshoe of claim 1, wherein the shoe is substantially rigid and comprises a metal.

12. An attenuating horseshoe comprising:
a substantially rigid horseshoe having a recess formed therein;
an attenuating material disposed within the recess; wherein the attenuating material comprises a fluid including a polymeric gel having a crosslinked elastomeric polymer and a coating sealing the fluid in the recess and
wherein the polymeric gel fills the channel substantially flush with the surface of the substantially rigid shoe.

13. (Canceled).

14. (Canceled).

15. (Canceled).

16. (Canceled).

17. (Canceled).

18. The horseshoe of claim 12, wherein the coating comprises a polyurethane.
